(19) United States
(12) Patent Application Publication
(10) Pub. No.: US 2002/0060376 A1
(43) Pub. Date: May 23, 2002

(54) Method and apparatus for producing an ink jet lenticular foil

(76) Inventors: Jerry C. Nims, Atlanta, GA (US); Paul F. Peters, Suwanee, GA (US); William M. Karszes, Rosewell, GA (US); Guido Desie, Mortsel (BE)

Correspondence Address: PATTON BOGGS LLP, 2550 M Street, N.W., Washington, DC, 20037, US

(21) Appl. No.: 09/988,382

(22) Filed: Nov. 19, 2001

Related U.S. Application Data
(60) Provisional application No. 60/249,258, filed on Nov. 17, 2000.

(51) Int. Cl. B29D 11/00

(52) U.S. Cl. 264/1.34; 264/1.6

(57) ABSTRACT

Printing resolution parameters of a printer, preferably an inkjet printer, are obtained. The printer resolution values are used to fabricate an extrusion tool for extruding lenticular sheets or foils. A lenticular sheet or foil is extruded with the fabricated extrusion tool to have spacing between microlenses proportional to the printer resolution value. One or more images are digitized and stored in a general purpose programmable computer. The general purpose programmable computer segments the data for each image into raster pixel lines and interleaves the segments into a merged file. A printer of the type from which the printing resolution parameters were obtained prints the merged file on the lenticular sheet.

Priority of this application is based on U.S. Provisional Application No. 60/249,258, filed on Nov. 17, 2000, which is hereby incorporated by reference.

### BACKGROUND OF THE INVENTION

1. Field of the Invention

The present invention relates to lenticular media and, more particularly, to a method and apparatus for fabricating lenticular sheets optimally matched to a particular printer's performance characteristics.

2. Statement of the Problem

The use of lenticular sheets to transmit images to appear to an observer as three-dimensional, and to appear different from different viewer positions, to give a perception of changing as the observer moves, is known. A summary of certain typical features, and some general examples, are given for convenience.

A lenticular sheet, as it is generally known, includes a plurality of semi-cylindrical lenses, or lenticules, arranged side-by-side, in a plane, each extending in the same direction. The lenticular sheet is typically formed of a substantially transparent plastic and is overlaid onto an ink-supporting substrate or medium on which a plurality of specially formatted images are disposed.

If the lenticular sheet is to transmit images to appear three dimensional, the plurality of images disposed on the underlying medium includes one or more left images and, typically, a corresponding number of right images. Each left image and right image may be of the same scene or arrangement of objects, with the relative position of objects or portions of objects being different in one with respect to the other, to mimic the parallax between the images impinging on an observer's left eye versus that impinging on his or her right eye. It is known in the art of imaging that a person's perception of three dimensions, when viewing a real world scene, is caused, in significant part, by the parallax between the image seen by the person's left eye verses that seen by the person's right eye. A typical camera does not capture this parallax, because it has only a single lens. Therefore, when a viewer looks at a photograph taken by a single lens camera, his or her left eye and right eye see exactly the same image. There is no parallax. For this reason, a typical photograph does not convey a three-dimensional feel, and flattens the appearance of objects.

A lenticular sheet, though, permits displaying an image on a hard copy surface to appear three-dimensional. One method is to take a picture of a scene from a first location, and then move the camera a lateral distance to a second location and take a picture of the same scene. The picture taken from the first position may be called the left image and the picture taken from the second position may be called the right image. There is a parallax between the two images, due to the lateral displacement between the respective positions from which the left and right pictures were taken. The parallax is exploited by rasterizing the left and right images or pictures into, for example, sixty-four vertical strips each. The rasterizing can be done by converting the pictures into a digital pixel array and then dividing the array into sixty-four strips, typically in a vertical direction. The left and right images are disposed on a medium, typically by placing the first vertical stripe of the left image next to the first vertical stripe of the right image, and then the second vertical stripe of the left image next to the second vertical stripe of the right image. The arrangement is typically repeated so that, for example, the sixty-four vertical stripes of the left image are interspersed with sixty-four vertical stripes of the right image, in an alternating pattern.

A lenticular sheet having, for example, sixty-four lenticules is placed over the two interspersed rasterized images, such that each lenticule runs parallel to, and extends above, at least one left image raster line and one right image raster line. Because the left and right raster lines have different positions under the lenticules, the light from the left image raster line will have a different angle of refraction passing through the lenticule than does the light from the right image raster line. The different angles of refraction are such that a person's left eye, when at a specific viewing angle and distance with respect to the medium, will see only the left image raster lines and the person's right eye will see only the right image raster lines. The person's left eye and right eye receive different images, the difference between the two being the parallax that the person would have actually observed if looking at the original scene. The person thus “sees” a three dimensional image.

Typically, placing two raster lines under each lenticule limits the viewing positions from which an observer will see a three dimensional image. The reason is that to see three dimensions the viewer must be in the position where only the left image raster lines are refracted to the viewer's left eye, and only the right image raster line are refracted to the viewer's right eye. At other viewing positions the viewer's eyes each receive both the left image and right image raster lines, or both eyes receive only left image raster lines or right image raster lines, which presents as a two-dimensional image.

To increase the number of viewing positions from which the observer will see a three-dimensional image, a greater number of rasterized images are created, and a correspondingly greater number of raster lines are disposed under each lenticule. For example, instead of a left eye and right eye picture taken from a single head-on view, a plurality of left/right pictures can be taken, each from a different view. Picking three views as an example, the above-described head-on view is generated as described, and then a first flank view is generated by taking a left eye picture and a right eye picture, from a position to the left and right, respectively, of a second view position. The second view position may be displaced, for example, 10 degrees left from the head-on position. Next a right flank view is generated by taking a left picture and a right picture, from a position to the left and right, respectively, of a third view position. The third view position is displaced, for this example, 10 degrees to the right of the head-on position.

There is a problem with the above-described multiple view method, though, namely the requirement for more raster lines. For example, the three above-described views require six pictures or images, to be displayed through the lenticular sheet. For such display, each of the six images or pictures must be segmented or rasterized into, for example, sixty-four vertical strips. The sixty-four vertical strips of each picture or image would then be interleaved so that a total of 364 vertical strips, or raster lines, are disposed on the substrate. The lenticular sheet would then be overlaid such that each lenticule covers six vertical strips or raster lines, namely one from each of the left and right pictures taken from each of the three above-described viewing perspectives.

Due to the differing positions of each of the six raster lines under the lenticule, the light from each undergoes a different angle of refraction as it passes through the lenticule. Because of the raster lines from the different images being diffracted differently, there is typically one viewing position at which the observer sees a three-dimensional image of the above-described head-on view. Assuming the raster lines are disposed accurately with respect to the lenticules, there is a second viewing position at which the observer sees a three-dimensional image of the left flank view. Likewise, assuming the raster lines are disposed accurately with respect to the lenticules, there is a third viewing position at which the viewer will see a three-dimensional view from the right flank viewing angle.

There is a problem with the multiple viewing angle method, as it requires a greater number of pixel or raster lines. It also requires that the pixel or raster lines be disposed accurately with respect to the lenticules.

Lenticular sheets also allow observers to see images which change as the observer changes his or her position with respect to the medium. The principle of operation is the same as that used for presenting images appearing to be three-dimensional. An example is a first picture or image being of a golfer holding a club in the upswing position, and a second image being of the golfer in the downswing position. The two images or pictures are rasterized. The raster lines of the two images are disposed on a medium, typically in a manner alternating between a raster line from the first picture, i.e. the golfer in the upswing position, followed by a raster line from the second picture, i.e. the golfer in the downswing position. The pattern is continued such that the two rasterized images are interlaced with one another. Then, a lenticular sheet is typically overlaid such that each lenticule covers two raster lines—one raster line from the first picture and one raster line from the second picture.

Due to the different positions under the lenticule, the light from the raster line corresponding to the first picture or image is diffracted at an angle different than the light from the raster line of the second picture or image. The different diffraction angles are such that the observer from a first viewing position sees only the raster lines from one of the two pictures or images while, from a second position, he or she sees only the raster lines from the other of the two pictures or images. Referring to the golf example, the observer would see the golfer in the upswing position from one viewing position and the downswing position from another viewing position.

The golfer example above used only two images. More than two images however, could be imaged, rasterized, disposed on a medium, and overlaid with a lenticular sheet. For example, a sequence of the golfer going through four positions can be displayed through a lenticular sheet as follows: First, the four positions would be photographed and rasterized. The four rasterized images would then be disposed on a printable medium or substrate. The arrangement would typically be the first raster line from each of the four pictures followed by the second raster line from each of the four pictures, and so on. A lenticular sheet would then be overlaid, typically such that each lenticule covered, for this example, four raster lines, one raster line from each of the four pictures. The location of each set of four raster lines under each lenticule is such that the observer sees only the raster lines from one of the four, depending on the viewing angle relative to the medium.

The above example of four positions of a golfer presents problems similar to the multiple three dimensional images. Namely, the greater the number of images, whether the images are different views of the same scene or different positions or degrees of zoom for an object, the greater the number of pixel lines that are required. The general relation between image quality and the number of pixel or raster lines amplifies these problems. Stated differently, both the quality of an image and the number of images or views that can be seen though a lenticular sheet are determined, in significant part, by the number and spacing of the raster lines and by the number of lenticules or microlenses. However, for any given size of image an increase in the number of raster lines necessarily decreases the line width, or the width of each pixel making up the line if the image is pixel-based. The increase in the number of raster lines not only decreases the line or pixel width; it also decreases the spacing from one raster line or pixel to the next.

The present inventors have identified inkjet printers as a preferred apparatus for printing lines of pixels, or raster lines, for viewing through a lenticular sheet. However, inkjet printers have inherent limitations as to the minimum dot size they can print, and limitations on the minimum spacing from one dot to the next. The prior art selects line widths and spacing based on trial-and-error, or to match standard or vendor-supplied lenticular sheets. Prior art lenticular sheets, however, are manufactured without particular consideration to the specific printing capabilities of the printer, or of the type of printer, that will be used to print the interleaved pixel lines, i.e., raster lines, on the medium. The spacing between the lenticules or microlenses, though, is one of the ultimate factors bearing on the width of the pixel lines, and the number and spacing of pixel lines. More particularly, if the number of pixel lines is selected which results in a line, or pixel width, or pixel-to-pixel spacing smaller than the ink-jet printer can produce the image quality will be substantially degraded. On the other hand, if the number of pixel lines is selected based on an overly conservative estimate of the printer's capabilities, the final product will have an image quality that is lower than what could have been obtained.

### SUMMARY OF THE INVENTION

These problems, and others, are overcome, and additional benefits are provided by a method according to the present invention. A first aspect of this invention includes providing an inkjet printer with a digital signal interface for communicating with a programmable computer or other digital image data processing and having a storage apparatus, and having a movable print head controlled by a servo. Next a measuring step measures the smallest increment that the servo can move the movable print head and generates a Least Interval Value data representing the measurement. Next, a microlens sheet is extruded with microlenses having a spacing between microlenses based on the Least Interval Value data.

An optional further feature of the above-summarized aspect is a step of applying an ink-receptive material on a surface to the microlens sheet.

A further feature of this aspect of the invention includes the step of printing a plurality of pixels on the ink-receptive material using a printer having a Least Interval Value substantially similar to the Least Interval Value measured by the measuring step.

Another aspect of the invention includes the steps of providing an inkjet printer with a digital signal interface for communicating with a programmable computer or other digital image data processing and having a storage apparatus, and having a movable print head controlled by a servo. Next a measuring step measures the smallest increment that the servo can move the movable print head and generates a Least Interval Value data representing the measurement. Next, an extrusion die is formed, having grooves for extruding a microlens, the grooves having a spacing based on the Least Interval Value.

An optional further feature of the above-summarized aspect of the invention includes a further step of extruding a microlens sheet using the extrusion die.

A still further feature of this aspect of the invention includes the step of depositing an ink-receptive material on a surface of the microlens sheet.

A further feature of this aspect of the invention includes the step of printing a plurality of pixels on the ink-receptive material using a printer having a Least Interval Value substantially similar to the Least Interval Value measured by the measuring step.

A further aspect of the invention identifies a plurality of similar kinds of inkjet printers, each having a digital signal interface for communicating with a programmable computer or other digital image data processing and having a storage apparatus, and having a movable print head controlled by a servo and then selects a sample of the plurality. Next, a measuring step measures the smallest increment that the servo of the sample can move the movable print head and generates a Least Interval Value data representing the measurement. Next, a microlens sheet is extruded with microlenses having a spacing between microlenses lenticules based on the Least Interval Value data.

A further feature of this aspect of the invention includes the step of depositing an ink-receptive material on a surface of the microlens sheet.

A further feature of this aspect of the invention includes the step of printing a plurality of pixels on the ink-receptive material using a printer having a kind that is among the plurality from which the sample was selected.

### BRIEF DESCRIPTION OF THE DRAWINGS

These and other objects of the invention will be clear upon a reading of the following detailed description of several preferred embodiments of the invention, together with the following drawings of which:

FIG. 1 is cross-sectional view of an example lenticular sheet formed in accordance with a method according to the present invention.

### DETAILED DESCRIPTION OF THE INVENTION

1. Overview

To facilitate a ready understanding of the novel aspects of the present invention, this description omits a detailed discussion of the methods and processes by which pictures, or computer generated images, or combinations of both, are digitized and processed into the format required for viewing through a lenticular sheet. Many methods and techniques for such processing are known to persons of ordinary skill in the art of computer generated and enhanced graphics, particularly three-dimensional graphics. Common to substantially all of the known methods is that a plurality of two-dimensional pictures or images are digitized into a pixel array, and the array is segmented into strips of pixels. For purposes of this description, a strip of pixels will be referenced as a “raster line.” It is known in the art that the raster lines are interleaved, using known data manipulation methods, and output to a printing apparatus. The novel aspects of the present invention relate to the spacing between the raster lines, and the structure and spacing between the microlenses of the lenticular sheet, and a system integrating these novel features in a further unique combination.

Further, the present invention may be implemented upon reading this disclosure through ready modifications of known methods for capturing pictures, digitizing and rasterizing the digital images, interleaving and formatting the rasterized images for output and printing. As will be understood, the readily performed modifications relate to calculating the pixel widths and raster line spacing in accordance with this description, and combining these into the system described herein.

2. Detailed Description

### Numerically Describing Printer Resolution Frequencies

An example method according to a first aspect of this invention starts with measuring the resolution frequency of at least one commercially available ink jet printer. There is a significant variety of commercially available ink jet printers, of varying sizes, having a wide range of specifications as to printing speed and resolution. The standard ratings for printer resolution are Lines Per Inch (LPI) or Dots Per Inch (DPI). Resolution is based on the inkjet printer having a placement grid of potential locations for depositing a drop or spot of ink, with the smallest granularity or minimum spacing of the grid being the smallest interval between placement of ink spots or droplets that the printer can realize, in the direction between adjacent grid lines. While larger intervals of placement may be possible, the least interval of placement in a direction has a minimum value determined by the construction of the selected printer. This parameter is measured and recorded, for purposes of this invention, as a Least Interval Value or Least Interval Value(i), where the index “i” may be used, if desired, to identify the particular model name or model number of the printer.

The Least Interval Value may be in accord with other published data of the printer, such as LPI or DPI. However, since the LPI and DPI of a printer may be nominal values that do not require exceptional precision, the Least Interval Value may vary from the LPI or DPI. Stated differently, two printers with the same published LPI or DPI may have different Least Interval values.

The Least Interval Value is determined by the design of the printer and the standards under which it is manufactured. The value typically is not subject to control by the end user. Further, the Least Interval Value normally does not substantially change over the typical useful life of the printer, provided the printer is maintained according to the manufacturer's recommendations.

The Least Interval Value may be a single value; preferably obtained as the best fit to test data obtained by measuring individual intervals performed by the printer. An average or mean may be used as an approximation of the best fit. The Least Interval Value may be a set of numbers including, for example, the average or mean, and a standard deviation, expressing regularized and consistent deviations of the print mechanism from the ideal step increment.

An example printer (not shown) for which the Least Interval Value is measured is the Sherpa 43™ printer, commercially available from Agfa Gevaert N.V., Belgium, or any of the known equivalents. An example determination of the Least Interval Value is carried out by issuing commands to the printer (not shown) causing its controller (not shown) to actuate its servos for the smallest possible movement of the print head. This numerically described smallest spacing interval is determined over the extent of the output according to the incremental positioning of the ink jet printer head. It is approximated by a single best fit value which specifies a numerical frequency having a substantial fit with the actual printer output which can deviate slightly but largely conforms to that numerical frequency in placing ink spots at the closest possible spacing on the receptive medium. Optionally, additional values that record consistent variance in the printer operation can be included in the Least Interval Data.

### Customized Extrusion Tool Manufacture

It is known that a lenticular sheet may be formed by extrusion using an extrusion roll or cylinder, as described in the Background section of U.S. Pat. No. 5,362,351. A step in accordance with the present invention forms shows an extrusion cylinder (not shown) to have a spacing SL between adjacent grooves (not shown) that is based on the Least Interval Value. The extrusion cylinder is an extrusion cylinder of a type such as described in the Background section of U.S. Pat. No. 5,362,351 that is used for rolling plastic in an industrial forming process for lenticular sheets. It will be understood that except for the particular spacing SL, and its determination, that the general structure and materials of the cylinder 2 are known in the art.

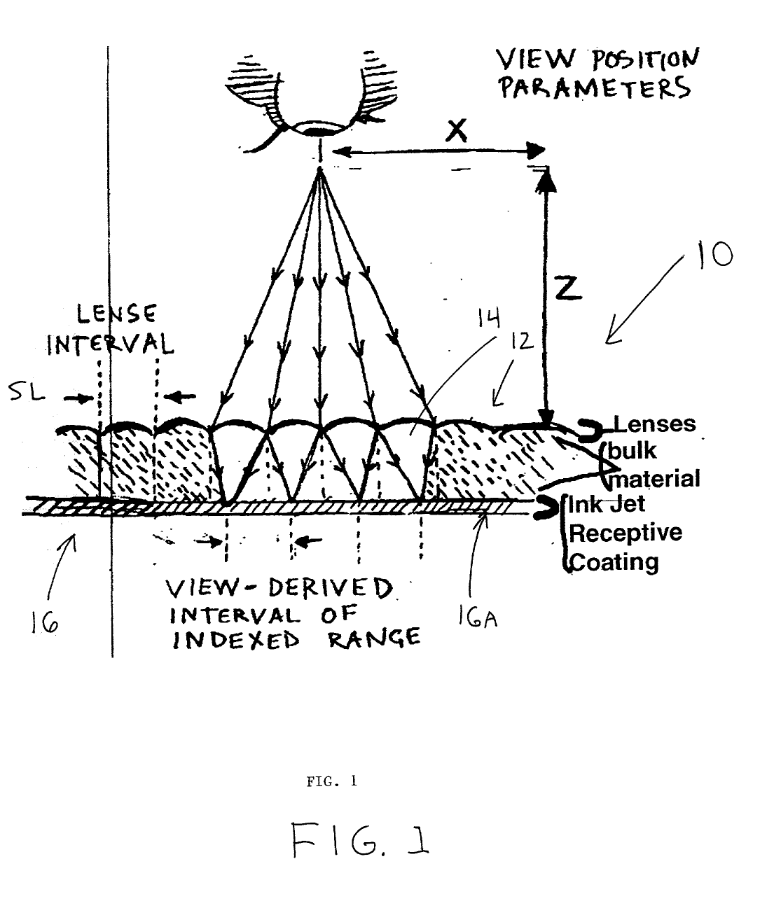

The extrusion cylinder consists of a metal cylinder that has been inscribed with a plurality of grooves, the plurality being the inverted profile of the array of optical elements (such as item 14 of FIG. 1) that are to be formed by the extrusion of a transparent material.

The extrusion cylinder s formed as follows: A starting cylinder (not shown) from which the cylinder is formed is mounted on a lathe (not shown) and engraved with a diamond-tipped tool (not shown) that has the cutting profile of one lens element. The engraving step itself is known in the art. In the preferred embodiment the diamond-tipped tool is repositioned for multiple cuts into the cylinder at a fixed interval that is in accordance with the Least Interval Value measurements obtained from the selected printer.

The cutting interval, or spacing SL, is fixed at a value that is proportional to the printing interval PITV. The printing interval PITV is the pixel line-to-pixel line spacing that will be printed by the printer. The ratio between SL and PITV is a parameter that is determined on an application specific basis for each of the several kinds of view-dependent display contemplated as being manufactured using a lenticular sheet or foil according to this invention. A general guideline is that the ratio of cutting interval SL to printing interval PITV is 1.0 for applications using a very long viewing distance, and the cutting interval SL increases proportionately to a ratio greater than 1.0 times the printing interval as the viewing distance in the specific application is reduced. The cutting interval SL can be increased by scaling its value by an integer factor such that two or more of the Least Interval Values are combined to make a larger interval SL.

### Extruded Material Formed According to Printer Least Interval Value

FIG. 1 shows a lenticular sheet, or foil 10, formed according to the present invention. The FIG. 1 lenticular foil for this example is formed by extrusion using the engraved cylinder described above. The extruded foil 10 has two sides, a first side 12 having a plurality of optical elements, or microlenses 14 and a second side 16 having an ink receptive coating or surface 16A. The plurality of optical elements, or microlenses 14 are spaced SL by the extrusion cylinder 2 and, accordingly, the spacing SL is based on the Least Interval Value frequency of a printer (not shown) selected to dispose ink on the surface 16A, with that Least Interval Value scaled by an application-specific parameter that determines optimal viewing distance and lens placement (SL) intervals.

The ink receptive coating 16A is preferably applied in a fabrication step separate from the extrusion step. An example step of depositing the ink-receptive coating is as follows: First, the following coating composition is prepared: in 960 g of water 21.8 g of gelatine and 16.0 g of polyvinylpyrrolidone (PVP K90) are dissolved at 36 degrees. To this solution 80 g of fine precipitated calciumcarbonate and 4 g of a polyacrylamide with a particle size of 20 micron is added and dispersed with a high-speed stirrer. Then nonionic and anionic surfactants are added to adjust the surface tension for good coating quality. The side 16 of the extruded material 10 opposite to the microlenses 14 is corona treated, and after this treatment the above-described example coating composition is applied at a wet coating weight of 130 g per square meter. After drying a matte white layer 16A with a total dry coating weight of 16 g per square meter is obtained.

In this example a gelatinous ink receptive coating 16A is applied to the back side 16 of a lenticular foil 10 using corona treatment for good adhesion. However, for those skilled in the art it will be understood that other kinds of substrate material can be used, provided that the lens structures 14 can be made in them, in combination with a subbing layer (not shown) that is applied to the back side, such as the side labeled as 16 in FIG. 1. Further, upon this subbing layer any ink receptive layer known in the art can be applied, i.e. polymeric binder layers comprising gelatines, polyvinylalcohols, polyvinylpyrrolidones, polyamines, polyethyleneamines, celluloses, and the like, and microporous layers comprising pigment particles such as silicas, TiO₂, aluminas and the like, and any combination of said layer structures.

The ink-receptive coating can be a single coating layer, such as 16A in FIG. 1, or it can comprise many different layer compositions applied to the substrate in a single pass or in multiple passes. Further, the ink receptive coatings can be applied to the lenticular foils in a separate fabrication step, as described in the example above, but this is not a limitation. For example, the ink-receptive layer or coating such as that shown as item 16A in FIG. 1 can be applied to the polymeric material in an inline coating step, or an inline coextrusion step.

### Extruded Material Printed by Printed by Printer Having Similar Least Interval

For this example, it is assumed that digital images, in any format convertible to a pixel representation, forming two “flip” positions of an object are input to a general purpose digital computer. The two positions may be digital scans of pre-existing pictures. Alternatively, a single image is input and the “flip” position image is generated within the computer using, for example, commercially available “morphing” software. The two “flip” images are then rasterized into pixel lines, or strips, or raster lines (not shown). The value SL is then input to the computer, where SL is the spacing between the microlenses 14 as shown in FIG. 1. The SL value is then employed, using optical geometry methods well-known in the art, to calculate the distance between adjacent pixel lines to be printed on the ink-receptive surface 16A.

For this example the previously identified Sherpa 43™ printer, commercially available from Agfa Gevaert N.V., Belgium, or any of the known equivalents, is used to print the two rasterized “flip” images in a mirror configuration on the ink-receptive surface 16A. The Sherpa 43™ printer was used to obtain the SL value. Therefore, the SL spacing between the microlenses 14 and the associated spacing between the printed pixel or raster lines matches the Least Interval Value of the Sherpa 43™ printer. After printing, the lenticular foil 10 is observed from the side 12 having the lenses 14, and by changing the viewing angle the observer sees one and then the other of the two flip images. As a result of the spacing between the pixel or raster lines, and the microlens spacing SL being associated with the Sherpa 43 or equivalent printer, the image quality is optimal and consistent.

It is contemplated that one or more kinds or model numbers of inkjet printers will have their Least Interval Value date measured and identified as sufficiently similar such that a single spacing SL can be used for any of such printers. In this case the lenticular sheet such as that shown in FIG. 1 could be sold with a list of printer identifiers for which the sheet would be compatible.

Instead of “flip” images the input to the general purpose programmable computer (not shown) could be three viewing angles of a scene for three-dimensional display through a lenticular sheet. As known in the art, each viewing angle comprises stereo images, namely a left image and a right image. As also known in the art, the left and right images need not be from pre-existing pictures. Instead, a “left” and “right” image could be created from a single picture, by selecting pixel regions within the picture and shifting the region to simulate the parallax that between an actual left and right picture. Further, as also known in the art, images of multiple objects could be retrieved from the computer storage (not shown), or input to the computer, and then merged into artificial scenes. It is further assumed that the one or more stereo images input to the computer, or generated by pixel-shifting, are rasterized into a plurality of pixel lines or strips, or raster lines (not shown).

The present invention has been described in terms of several preferred embodiments. However, various obvious additions and changes to the preferred embodiments are likely to become apparent to persons skilled in the art upon a reading and understanding of the foregoing specification. Further, it will be understood that the specific structure, form and arrangement of parts depicted and described are for purposes of example only, and are not intended to limit the scope of alternative structures and arrangements contemplated by this invention. Instead, the depicted examples are to assist persons of ordinary skill in understanding the principles, features and practical considerations of this invention and, based on the example and other descriptions herein, make and use it and any of its alternative embodiments that will be obvious upon reading this disclosure.

I claim:

1. A method for forming a lenticular sheet comprising steps of:
providing an inkjet printer having a digital signal interface for communicating with a programmable processor and having a movable print head selectively moved by a servo in response to externally generated commands received through the digital signal interface;
measuring the smallest increment that the servo can move the movable print head;
generating a least increment data representing the smallest increment measured by the measuring step; and
extruding a lenticular sheet having a plurality of parallel microlenses with a spacing between adjacent ones of said plurality of microlenses based on the least increment data.

2. A method according to claim 1 wherein the lenticular sheet has a first and second surfaces parallel surfaces, and the microlenses are formed on the first surface, and further including the step of applying an ink receptive material to the second surface.

3. A method for displaying images through a lenticular sheet comprising steps of:
providing an inkjet printer having a digital signal interface for communicating with a programmable processor and having a movable print head selectively moved by a servo in response to externally generated commands received through the digital signal interface;
measuring the smallest increment that the servo can move the movable print head;
generating a least increment data representing the smallest increment measured by the measuring step;
extruding a lenticular sheet having a plurality of parallel microlenses with a spacing between adjacent ones of said plurality of microlenses based on the least increment data;
forming an ink-receptive surface on said lenticular sheet;
providing a printer having a smallest increment measurement within a predetermined range of said least increment data; and
printing a plurality of pixel lines on said ink-receptive surface, the plurality of pixel lines having a spacing based on said least increment value.

4. A method for forming an extrusion tool comprising steps of:
providing an inkjet printer having a digital signal interface for communicating with a programmable processor and having a movable print head selectively moved by a servo in response to externally generated commands received through the digital signal interface;
measuring the smallest increment that the servo can move the movable print head;
generating a least increment data representing the smallest increment measured by the measuring step; and
forming an extrusion cylinder having a plurality of grooves for extruding a lenticular sheet having microlenses corresponding to said plurality of grooves, said grooves having a spacing based on said least increment data.

5. A method for forming a lenticular sheet comprising steps of:
providing a plurality of inkjet printers of different kinds, each having a digital signal interface for communicating with a programmable processor and having a movable print head selectively moved by a servo in response to externally generated commands received through the digital signal interface;
measuring for each of the plurality of inkjet printers the smallest increment that the servo can move the movable print head;
generating for a plurality of least increment data representing the plurality of smallest increments measured by the measuring step;
identifying the inkjet printers within said plurality of inkjet printers having a least increment data within a predetermined range of one another;
extruding a lenticular sheet having a plurality of parallel microlenses with a spacing between adjacent ones of said plurality of microlenses based on at least one of the least increment data of the printers within said inkjet printers identified by said identifying step.

6. A method according to claim 1 wherein said extruding step is further based on a viewing parameter associated with a desired viewing distance.

7. A method according to claim 3 wherein said extruding step is further based on a viewing parameter associated with a desired viewing distance.

8. A method according to claim 7 wherein said spacing between said pixel lines is further based on said viewing parameter.

9. A method according to claim 5 wherein said extruding step is further based on a viewing parameter associated with a desired viewing distance.

10. A method according to claim 5 further including the step of applying an ink-receptive material to said lenticular sheet.

11. A method according to claim 10 further including steps of:
providing a printer of a kind associated with at least one of the inkjet printers identified by said identifying step; and
printing with the printer provided by said providing step a plurality of pixel lines on said ink-receptive surface, the plurality of pixel lines having a spacing based on said least increment value.
